(19) United States
(12) Patent Application Publication
(10) Pub. No.: US 2015/0277629 A1
(43) Pub. Date: Oct. 1, 2015

(54) CAPACITIVE TOUCH-SENSITIVE DEVICE

(71) Applicant: TPK Universal Solutions Limited, Hong Kong (CN)

(72) Inventors: Kuo-Feng Kao, Xinbei (TW); Sung-Chien Huang, Taoyuan (TW); Wee-Hong Leong, Kuala Lumpur (MY); Shiang-Ting Wu, Taoyuan (TW)

(21) Appl. No.: 14/672,221

(22) Filed: Mar. 29, 2015

(30) Foreign Application Priority Data
Mar. 31, 2014 (CN) 201410127708.3

(51) Int. Cl. G06F 3/044

(52) U.S. Cl. CPC G06F 3/044

(57) ABSTRACT

A capacitive touch-sensitive device includes a sensor electrode layer, a signal trace layer, a flexible circuit board and an electrically-conductive adhesive layer. The sensor electrode layer includes electrically isolated sensor lines. The signal trace layer includes electrically isolated signal lines, each having an outer terminal portion coupled to a respective one of the sensor lines. The flexible circuit board has isolated mutually bonding pads, each corresponding to the outer terminal portion. The electrically-conductive adhesive layer includes a plurality of zones, each having a first adhesive matrix and first conductors dispersed therein. The first conductors bridge the outer terminal portion to the bonding pad.

### BACKGROUND OF THE INVENTION

This application claims priority to Chinese Application Serial Number 201410127708.3, filed on Mar. 31, 2014, which is herein incorporated by reference.

### FIELD OF THE INVENTION

The disclosure relates to touch-sensitive technology, more particularly to a capacitive touch-sensitive device with stable signal transmission.

### RELATED ART OF INVENTION

Referring to FIG. 1, U.S. Patent Application Publication No. 20010046021A1 discloses a conventional anisotropic conductive film 1 (ACF), which includes an insulative adhesive layer 11 which is made from resin, and a plurality of metal conductor particles 12 dispersed in the insulative adhesive layer 11. Such conventional anisotropic conductive film 1 is mainly adapted to be disposed between a capacitive touch-sensitive device and a flexible printed circuit board (FPC) to electrically and correspondingly connect signal lines of the capacitive touch-sensitive device with bonding pads of the flexible printed circuit board (i.e., to perform bonding), such that vertical pairs of the signal lines and bonding pads are electrically connected while adjacent signal lines or adjacent bonding pads are not.

Skilled artisans in the art tend to reduce the particle diameter of the metal conductor particles 12 to further prevent line-to-line or pad-to-pad connections from the conventional anisotropic conductive film 1, so as to increase precision of signal transmission.

With development of the technology, nano-metals are gradually adopted for making the signal lines instead of silver pastes or copper. However, when the conventional anisotropic conductive film 1 bridges the signal lines of the capacitive touch-sensitive device and the bonding pads of the flexible printed circuit board, the signal lines made of the nano-metals with a relative low density may result in problems such as unstable signal transmission or open circuit.

From the description above, it is clear that improving the bridging efficiency between the signal lines and the flexible circuit board to overcome the problems such as open circuit of signals and instability of signals may be a task for the skilled artisans.

### SUMMARY OF THE INVENTION

Therefore, an object of the disclosure is to provide a capacitive touch-sensitive device that may alleviate at least one of the drawbacks of the prior arts.

According to the disclosure, a capacitive touch-sensitive device may include a transparent substrate, a sensor electrode layer, a signal trace layer, a flexible circuit board and an electrically-conductive adhesive layer. The sensor electrode layer is disposed on the transparent substrate and includes a plurality of mutually electrically isolated sensor lines. The signal trace layer is disposed on the transparent substrate and includes a plurality of mutually electrically isolated signal lines, each having an outer terminal portion that is coupled to a respective one of the sensor lines of the sensor electrode layer. The flexible circuit board has a plurality of mutually electrically isolated bonding pads, each corresponding in position to the outer terminal portion of a respective one of the signal lines of the signal trace layer. The electrically-conductive adhesive layer is disposed between the outer terminal portions of the signal trace layer and the flexible circuit board and includes a plurality of first zones that are spaced apart from each other and that respectively correspond to the outer terminal portions of the signal trace layer. Each of the first zones has a first adhesive matrix and a plurality of first conductors dispersed in the first adhesive matrix. The first conductors of each of the first zones electrically bridge the respective one of the outer terminal portions of the signal trace layer to a respective one of the bonding pads of the flexible circuit board.

### BRIEF DESCRIPTION OF THE DRAWINGS

Other features and advantages of the disclosure will become apparent in the following detailed description of the exemplary embodiments with reference to the accompanying drawings, of which:

FIG. 1 is a fragmentary schematic sectional view of a conventional anisotropic conductive film disclosed in U.S. Application Publication No. 20010046021A1;

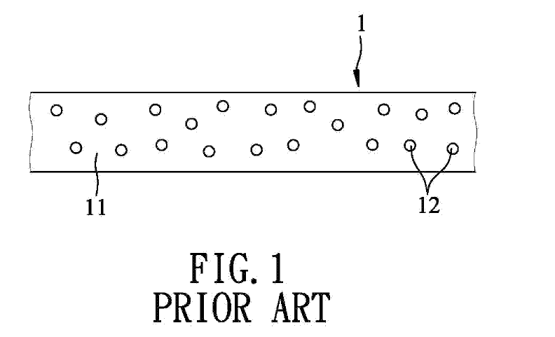

FIG. 2 is a top schematic view of a first exemplary embodiment of a capacitive touch-sensitive device according to the present disclosure;

FIG. 3 is a fragmentary sectional schematic view of the capacitive touch-sensitive device taken along line III-III in FIG. 2;

FIG. 4 is a partly enlarged view of FIG. 2;

FIG. 5 is a fragmentary schematic diagram of the first exemplary embodiment, illustrating a plurality of spherical-shaped first conductors;

FIG. 6 is a schematic diagram of a second exemplary embodiment according to the present disclosure, illustrating that the first conductors are configured as spiked spheres;

FIG. 7 is a schematic diagram of a third exemplary embodiment according to the present disclosure, illustrating that the first conductors are configured as wires;

FIG. 8 is a top schematic view of a fourth exemplary embodiment of the capacitive touch-sensitive device according to the present disclosure, illustrating a sensor electrode layer;

FIG. 9 is a fragmentary perspective view of the fourth exemplary embodiment, illustrating the detail structure of the sensor electrode layer; and

FIG. 10 is a top schematic view of a seventh exemplary embodiment of the capacitive touch-sensitive device according to the present disclosure.

### DETAILED DESCRIPTION OF THE DISCLOSURES

Before the disclosure is described in greater detail, it should be noted that like elements are denoted by the same reference numerals throughout the disclosure.

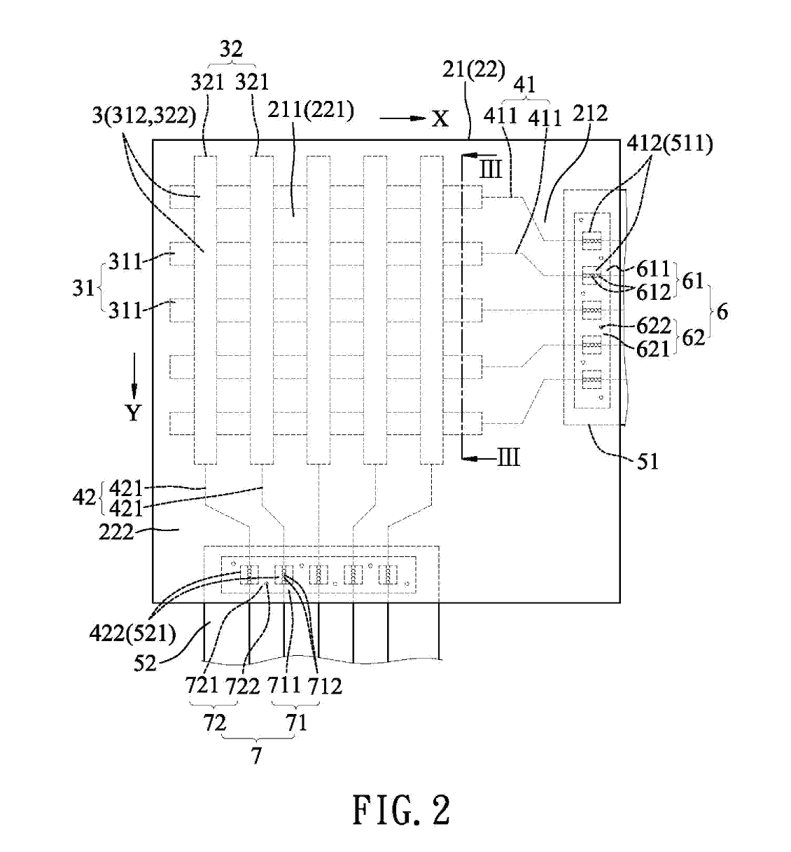

Referring to FIGS. 2 to 5, a first exemplary embodiment of a capacitive touch-sensitive device according to the present disclosure is adapted to be disposed at a front side of a flat panel display (FPD) to constitute a touch panel, and to allow a user to control the same using his/her finger(s) from the front side of the flat panel display. The capacitive touch-sensitive device of the first exemplary embodiment includes a lower transparent substrate 21, an upper transparent substrate 22, a lower sensor electrode layer 31, an upper sensor electrode layer 32, a lower signal trace layer 41, an upper signal trace layer 42, a lower flexible circuit board 51, an upper flexible circuit board 52, a lower electrically-conductive adhesive layer 6, an upper electrically-conductive adhesive layer 7, a transparent cover plate 8, a lower optical adhesive layer 91 and an upper optical adhesive layer 92. The transparent cover plate 8 covers the lower and upper sensor electrode layers 31, 32 and the lower and upper signal trace layers 41, 42. The lower optical adhesive layer 91 is attached to and between the lower and upper sensor electrode layers 31, 32, and the upper optical adhesive layer 92 is attached to and between the upper transparent substrate 22 and the transparent cover plate 8. Simply put, in this embodiment, the capacitive touch-sensitive device is configured into a double ITO (DITO) structure.

The lower and upper transparent substrates 21, 22 are spaced apart from and face each other, each having a viewable zone 211, 221 and a trace zone 212, 222 adjacent to the viewable zone 211, 221. Suitable materials for making the upper and lower transparent substrates 21, 22 may include, but are not limited to, polyethylene terephthalate (PET), polyethersulfones, polymethyl acrylate, polymethyl naphthalate, polyphenylene sulfide (PPS), polyallyl polymer, polycarbonate(PC) and glass.

The lower and upper sensor electrode layers 31, 32 are respectively formed on the lower and upper transparent substrates 21, 22. The lower sensor electrode layer 31 has a plurality of mutually electrically isolated first sensor lines 311, and the upper sensor electrode layer 32 has a plurality of mutually electrically isolated sensor lines 321. Each of the first and second sensor lines 311, 321 has a plurality of sensing zones 312, 322 that are spaced apart from each other. The first sensor lines 311 extend along a first direction (X), are disposed at the viewable zone 211 of the lower transparent substrate 21, and are arranged to be mutually spaced apart along a second direction (Y) substantially perpendicular to the first direction (X). The second sensor lines 321 extend along the second direction (Y), are disposed at the viewable zone 221 of the upper transparent substrate 22, and are arranged to be mutually spaced apart along the first direction (X), such that the sensing zones 322 of the second sensor lines 32 correspondingly overlap the sensing zones 312 of the first sensor lines 31 to constitute multiple capacitive sensing zones 3. In this embodiment, the lower and upper sensor electrode layers 31, 32 may be made of a transparent conductive material. Examples of the transparent conductive material may include, but are not limited to, indium tin oxide (ITO), indium zinc oxide (IZO), cadmium tin oxide (CTO), aluminum zinc oxide (AZO), indium tin zinc oxide (ITZO), zinc oxide, cadmium oxide (CdO), hafnium oxide (HfO), indium gallium zinc oxide (InGaZnO), indium gallium zinc magnesium oxide (InGaZnMgO), indium gallium magnesium oxide (InGaMgO), indium gallium aluminum oxide (InGaAlO), silver nano-wires, carbon nano-tubes and graphenes.

The lower and upper signal trace layers 41, 42 are respectively formed at the lower and upper transparent substrates 21, 22. The lower signal trace layer 41 includes a plurality of mutually electrically isolated first signal lines 411, and the upper signal trace layer 42 includes a plurality of mutually electrically isolated signal lines 421. Each of the first and second signal lines 411, 421 has an outer terminal portion 412, 422. The outer terminal portions 412 of the first signal lines 411 extend along the first direction (X), and the outer terminal portions 422 of the second signal lines 421 extend along the second direction (Y). In addition, the outer terminal portions 412 of the first signal lines 411 are mutually spaced apart in the second direction (Y) and are correspondingly connected to the first sensor lines 311 of the lower sensor electrode layer 31. The outer terminal portions 422 of the second signal lines 421 are mutually spaced apart in the first direction (X) and are correspondingly connected to the second sensor lines 321 of the upper sensor electrode layer 32. In this embodiment, the first signal lines 411 of the lower signal trace layer 41 are disposed at the trace zone 212 of the lower transparent substrate 21, and the second signal lines 421 of the upper signal trace layer 42 are disposed at the trace zone 222 of the upper transparent substrate 22. It is worth noting that, in other embodiments, the trace zone 212 of the lower transparent substrate 21 and the trace zone 222 of the upper transparent substrate 22 may be formed at various positions of the corresponding substrate based on various tracing demands of the touch-sensitive device and is not limited to what is described herein.

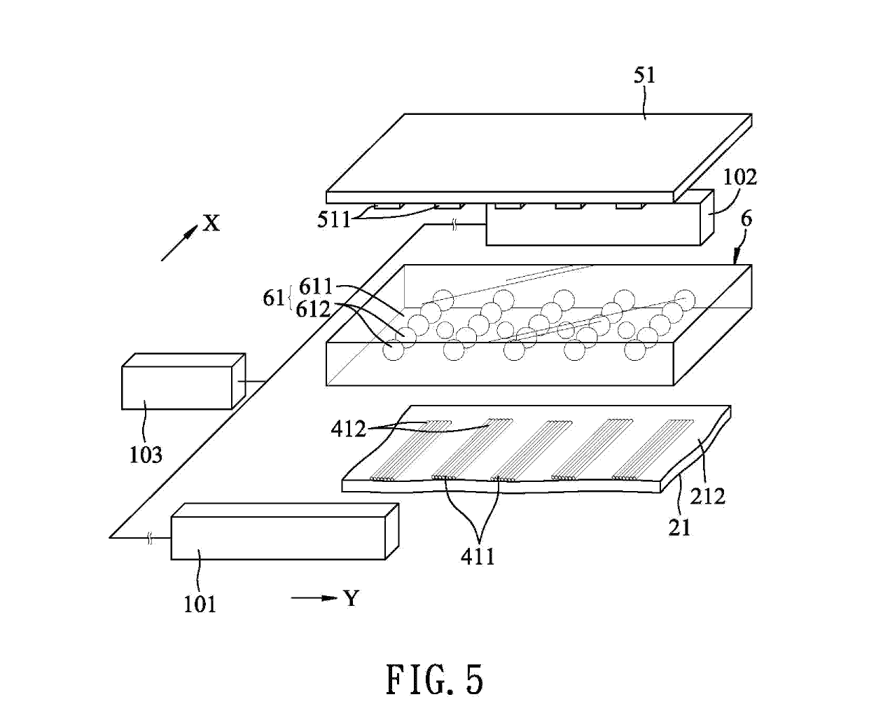

Preferably, as shown in FIG. 5, the first and second signal lines 411, 421 of the lower and upper signal trace layers 41, 42 are made from nano-metals, such as silver nano-wires. In this embodiment, the silver nano-wires have a diameter ranging from 20 μm to 80 μm.

Referring back to FIG. 2, the lower flexible circuit board 51 includes a plurality of mutually electrically isolated bonding pads 511, each corresponding in position to the outer terminal portion 412 of a respective one of the first signal lines 411. Similarly, the upper flexible circuit board 52 includes a plurality of mutually electrically isolated bonding pads 521, each corresponding in position to the outer terminal portion 422 of a respective one of the second signal lines 421.

The lower electrically-conductive adhesive layer 6 is disposed between the outer terminal portions 412 of the first signal lines 41 and the lower flexible circuit board 51, and has a plurality of first zones 61 that are spaced apart from each other and that respectively correspond to the outer terminal portions 412 of the first signal lines 411, and a plurality of second zones 62 that are respectively disposed between adjacent pairs of the firs zones 61. Each of the first zones 61 has a first adhesive matrix 611 and a plurality of first conductors 612 dispersed in the first adhesive matrix 611. Each of the second zones 62 has a second adhesive matrix 621 and a plurality of second conductors 622 dispersed in the second adhesive matrix 621. Through the first conductors 612 of the first zones 61, the outer terminal portions 412 of the first signal lines 41 are bonded respectively to the bonding pads 511 of the lower flexible circuit board 51.

The upper electrically-conductive adhesive layer 7 is disposed between the outer terminal portions 422 of the upper signal trace layer 42 and the upper flexible circuit board 52, and has a plurality of first zones 71 that are spaced apart from each other and that respectively correspond to the outer terminal portions 422 of the second signal lines 421, and a plurality of second zones 72 that are respectively disposed between adjacent pairs of the first zones 71. Each of the first zones 71 has a first adhesive matrix 711 and a plurality of first conductors 712 dispersed in the first adhesive matrix 711. Each of the second zones 72 has a second adhesive matrix 721 and a plurality of second conductors 722 dispersed in the second adhesive matrix 721. Through the first conductors 711 of the first zones 71, the outer terminal portions 422 of the second signal lines 42 are bonded respectively to the bonding pads 521 of the upper flexible circuit board 52.

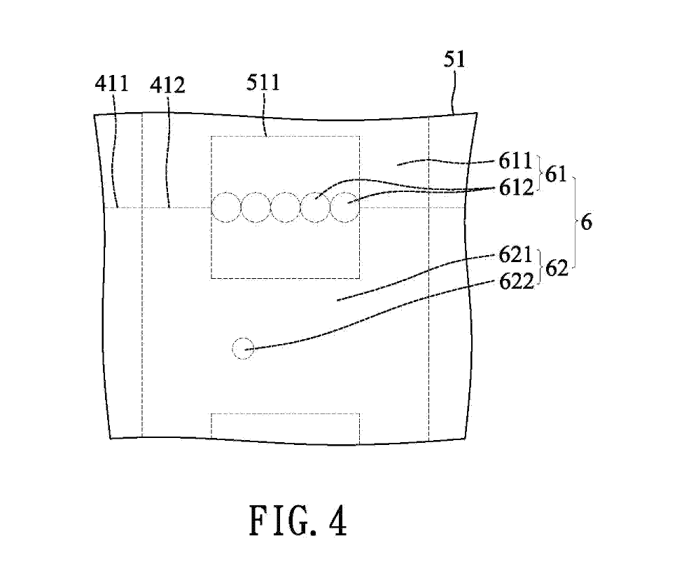

Preferably, a dispersion density of the first conductors 612, 712 in each of the first zones 61, 71 of the lower and upper electrically-conductive adhesive layers 6, 7 is greater than that of the second conductors 622, 722 in each of the second zones 62, 72 (as shown in FIG. 4, where only the lower electrically-conductive adhesive layer 6 is illustrated; in addition, only one second conductor 622 is shown for the sake of brevity). More preferably, the dispersion density of the first conductors 612, 712 in each of the first zones 61, 71 ranges from 750 N(number)/mm² to 4500 N/mm², and the dispersion density of the second conductors 622, 722 in each of the second zones 62, 72 is less than 750 N/mm². In this embodiment, the first conductors 612, 712 of each of the first zones 61, 71 are mutually electrically coupled, and the second conductors 622, 722 of each of the second zones 62, 72 are mutually electrically isolated.

The first conductors 612, 712 suitable for this disclosure may be configured as spheres, spiked spheres, or wires. In this embodiment, the first adhesive matrixes 611, 711 and the second adhesive matrixes 621, 721 are made of a transparent resin material, and the first conductors 612, 712 are configured as spheres having an average diameter ranging from 20 μm to 45 μm. The first conductors 612 in each of the first zones 61 of the lower electrically-conductive adhesive layer 6 are sequentially arranged into multiple rows, in which the first conductors 612 contact each other and are arranged substantially parallel to an axial direction (i.e., the first direction (X)) of the outer terminal portions 412 of the first signal lines 411 (i.e., silver nano-wires in this embodiment). The first conductors 712 in each of the first zones 71 of the upper electrically-conductive adhesive layer 7 are sequentially arranged into multiple rows, in which the first conductors 712 contact each other and are arranged substantially parallel to an axial direction (i.e., the second direction (Y)) of the outer terminal portions 422 of the second signal lines 421 (i.e., silver nano-wires in this embodiment).

In greater detail, for instance, as illustrated in FIG. 5, when disposing the lower electrically-conductive adhesive layer 6 between the outer terminal portions 412 of the first signal lines 411 and the lower flexible circuit board 6, a pair of electrode plates 101, 102 can be simultaneously provided at outer sides of the lower electrically-conductive adhesive layer 6 to be substantially parallel to the second direction (Y). A power supply 103 electrically connected to the electrode plats 101, 102 may be used for providing electrical energy to the electrode plates 101, 102 such that an electric field is generated between the electrode plates 101, 102, so as to arrange the first conductors 612 into the multiple rows substantially along the first direction (X).

From the description of the first exemplary embodiment above, by simultaneously tuning, for the first conductors 612, 712 in the first zones 61, 71, the dispersion density (e.g., greater than the dispersion density of the second conductors 622, 722 in the second zones 62, 72), the average diameter (e.g., ranging from 20 μm to 45 μm) and arrangement (e.g., parallel rows along the first direction (X) or the second direction (Y)) and utilizing the metal nano-wires (such as silver nano-wires) as the first and second signal lines 411, 421 of the first and second signal trace layers 41, 42, conducting areas between the first conductors 612, 712 of the first and second zones 61, 71 and the outer terminal portions 412, 422 of the first and second signal trace layers 41, 42 can be assured to be greater than 500 μm². As such, the above-mentioned problems associated with the prior art, such as instability of signal transmission or open circuit can be alleviated. It is worth noting that, the aforesaid tuning factors, such as the dispersion density, the average diameter and the arrangement of the first conductors 612, 712 are not necessarily to be simultaneously adopted. That is, in other embodiments, one or more of the tuning factors may be selected to improve the conducting areas between the first conductors 612, 712 and the outer terminal portions 412, 422 of the lower and upper signal trace layers 41, 42.

It is specifically worth noting that, in this embodiment, the lower and upper electrically-conductive adhesive layers 6, 7 may be used as anisotropic electrically-conductive films (ACFs).

It should be further noted that, in this embodiment, although the second adhesive matrixes 621, 721 of the second zones 62, 72 of the electrically-conductive adhesive layers 6, 7 have the second conductors 622, 722 dispersed therein, stability of signal transmission of the capacitive touch-sensitive device can be further assured by removing the second conductors 622, 722 from the second adhesive matrixes 621, 721 (e.g., using laser devices to burn off the second conductors), so as to prevent electrical connections between adjacent two of the bonding pads 511, 521 or even between adjacent two of the outer terminal portions 412, 422 of the first and second signal lines 411, 412 when bonding the lower and upper electrically-conductive adhesive layers 6, 7 correspondingly to the lower and upper flexible circuit boards 51, 52 and to the outer terminal portions 412, 422 of the lower and upper signal trace layers 41, 42.

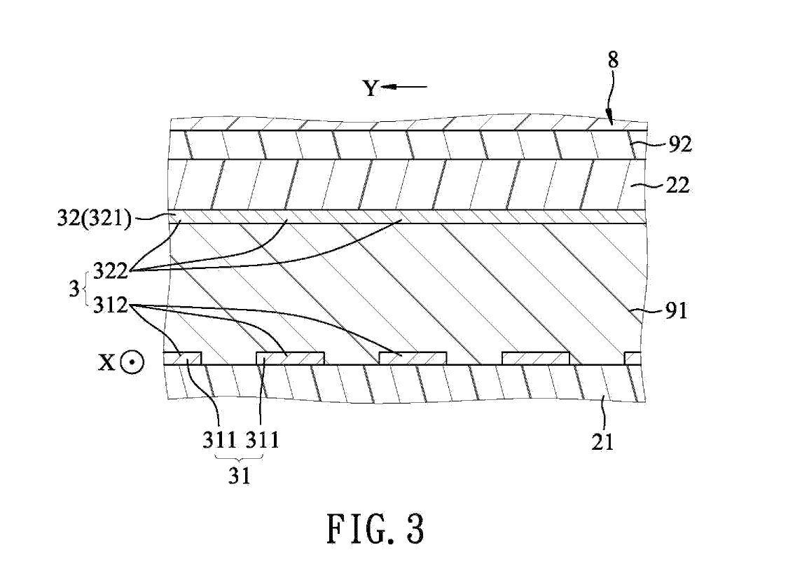

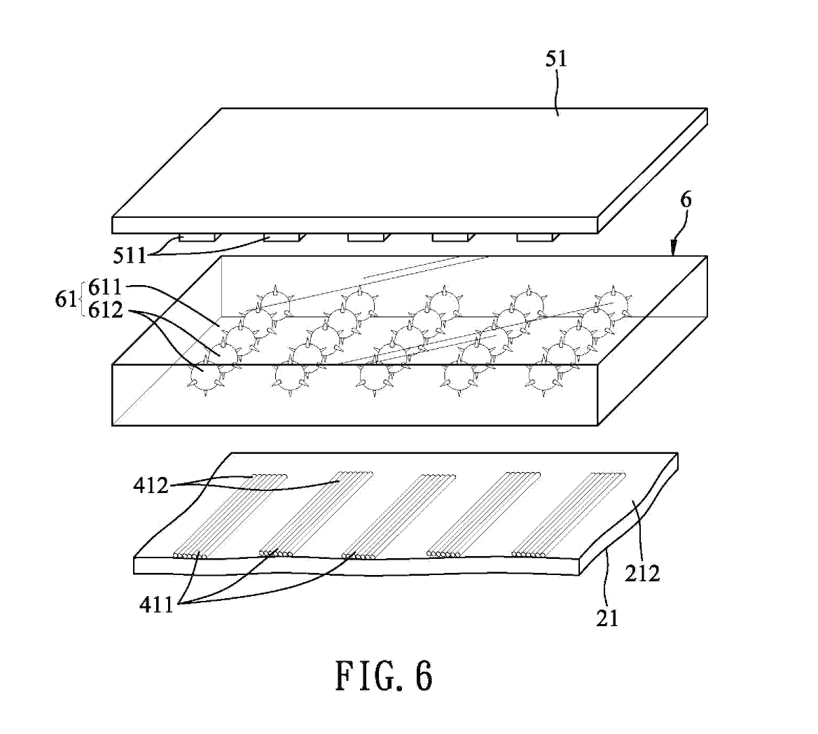

Referring to FIG. 6, a second exemplary embodiment of the capacitive touch-sensitive device according to the present disclosure is shown to be substantially similar to that of the first exemplary embodiment (as shown in FIGS. 2 and 3), with the difference residing in that the first conductors 612, 712 are configured as spiked spheres. The number of spikes formed on the first conductors 612, 712 may vary in different embodiments and is not limited to what is illustrated in the drawings according to the present disclosure. The main purpose to configure the first conductors 612, 712 as spiked spheres is to further increase the surface area of the first conductors 612, 712, so as to increase the conducting areas between the first conductors 612, 712 of the first zones 61, 71 and the outer terminal portions 412, 422 of the lower and upper signal trace layers 41, 42.

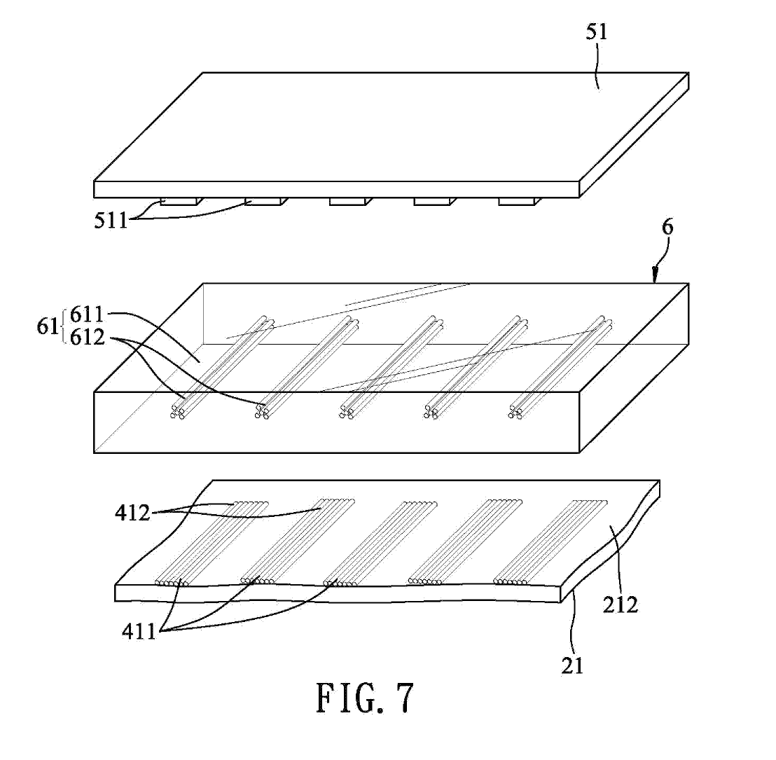

Referring to FIG. 7, a third exemplary embodiment of the capacitive touch-sensitive device according to the present disclosure is shown to be similar to that of the first exemplary embodiment (as shown in FIGS. 2 and 3). The difference resides in that the first conductors 612, 712 are configured as wires. In addition, the first conductors 612 are arranged into multiple bundles, and an axial direction of each of the first conductors 612 is substantially parallel to the axial direction of the outer terminal portions 412 of the first signal lines 411 (i.e., the first direction (X)). The first conductors 712 are arranged into multiple bundles, and an axial direction of each of the first conductors 712 is substantially parallel to the axial direction of the outer terminal portions 422 of the second signal lines 421 (i.e., the second direction (Y)). In this embodiment, the first conductors 612, 712 are silver nano-wires. Similarly, the main purpose to so configure the first conductors 612, 712 is to assure that the first conductors 612, 712 can be correspondingly arranged along the axial directions of the outer terminal portions 412, 422 of the signal lines 411, 421, so as to further increase the conducting areas between the first conductors 612, 712 of the first zones 61, 71 and the outer terminal portions 412, 422 of the lower and upper signal trace layers 41, 42.

It is worth noting that the first conductors 612, 712 of the second (or third) exemplary embodiment may be arranged in the multiple rows correspondingly along the first direction (X) and the second direction (Y) using the aforesaid method of the first exemplary embodiment (i.e., utilizing external electric field by electrode pads 101, 102).

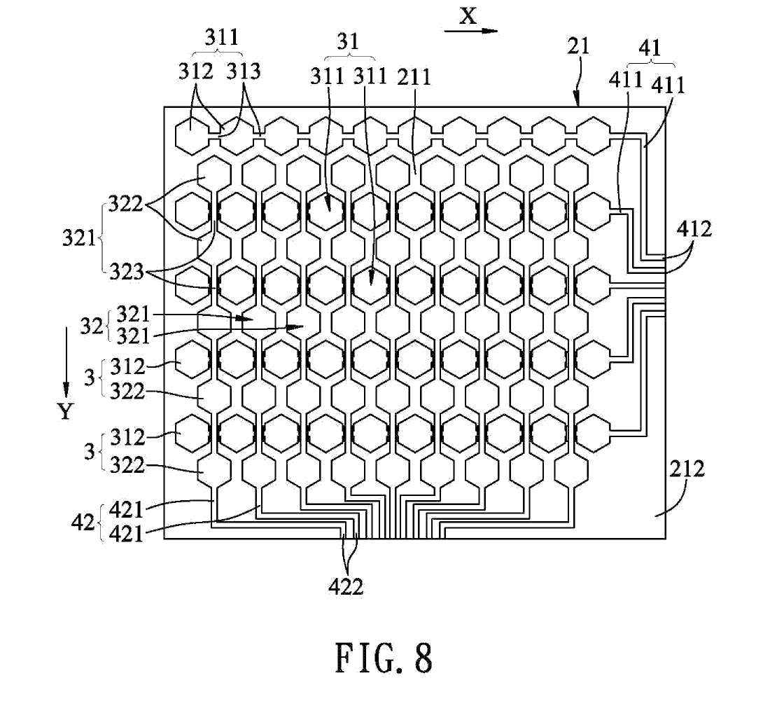

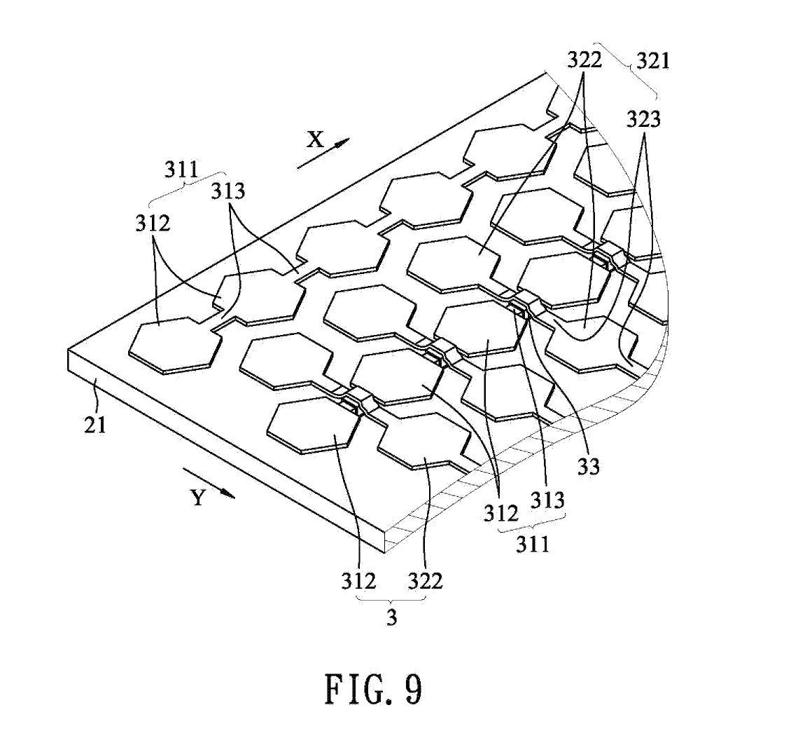

Referring to FIGS. 8 and 9, the capacitive touch-sensitive device of a fourth exemplary embodiment according to the present disclosure is shown to be similar to that of the first exemplary embodiment. The differences reside mainly in that the lower transparent substrate 21 of the fourth exemplary embodiment further includes a plurality of insulators 33 (see FIG. 8), and that the upper transparent substrate 22 and the lower optical adhesive layer 91 are omitted in the fourth exemplary embodiment. Simply put, the fourth exemplary embodiment of the capacitive touch-sensitive device is configured into a single ITO (SITO) structure

In greater detail, each of the first sensor lines 311 further has a plurality of connecting segments 313 interconnecting the first sensing zones 312, and each of the second sensor lines 321 further has a plurality of connecting segments 323 interconnecting the second sensing zones 322. The first sensor lines 311 extend along the first direction (X) to be disposed at the viewable zone 211 of the lower transparent substrate 21, and are mutually spaced apart in the second direction (Y). The second sensor lines 321 extend along the second direction (Y) to be disposed at the viewable zone 211 of the lower transparent substrate 21, and are mutually spaced apart in the first direction (X), such that the connecting segments 323 of the second sensor lines 321 overlap respectively the connecting segments 313 of the first sensor lines 311. Each of the sensing zones 312 of the first sensor lines 311 cooperates with one of the second sensing zones 322 of an adjacent one of the second sensor lines 321 to constitute the capacitive sensing zone 3.

The first signal lines 411 are disposed at the trace zone 212 of the lower transparent substrate 21, and so do the second signal lines 421. The insulators 33 are correspondingly disposed between the connecting segments 323 of the second sensor lines 321 and the connecting segments 313 of the first sensor lines 311.

The capacitive touch-sensitive device of a fifth exemplary embodiment according to the present disclosure is similar to that of the fourth exemplary embodiment (as shown in FIGS. 8 and 9), with the only difference residing in that the first conductors 612, 712 of the electrically-conductive adhesive layers 6, 7 are configured as spiked spheres as illustrated in FIG. 6.

The capacitive touch-sensitive device of a sixth exemplary embodiment according to the present disclosure is similar to that of the fifth exemplary embodiment (as shown in FIGS. 8 and 9), with the difference residing in that the first conductors 612, 712 of the electrically-conductive adhesive layers 6, 7 are configured as silver nano-wires (as illustrated in FIG. 7).

As shown in FIG. 8, the first signal lines 411 and the second signal lines 421 of the fourth, fifth and sixth exemplary embodiment are disposed correspondingly on opposite sides of the lower transparent substrate 21. The first and second signal lines 411, 421 may be disposed on the same side of the lower transparent substrate 21. However, people having ordinary skill in the art will appreciate that, with the same number of the sensor lines in the capacitive touch-sensitive device, when switching from the DITO structure to the SITO structure, the number of signal lines disposed on the lower transparent substrate 21 become relatively large. As such, when the first and second signal lines 411, 421 are all disposed on the same side of the lower transparent substrate 21, the flexible circuit board to be bonded with the first and second signal lines 411, 421 may be too long or occupy too large an area. Therefore, in some embodiments, such as the fourth, fifth or sixth exemplary embodiment, a multilayered flexible circuit board (not shown) formed with copper through holes may be utilized to reduce the cost of the flexible circuit board and to prevent mechanical interference.

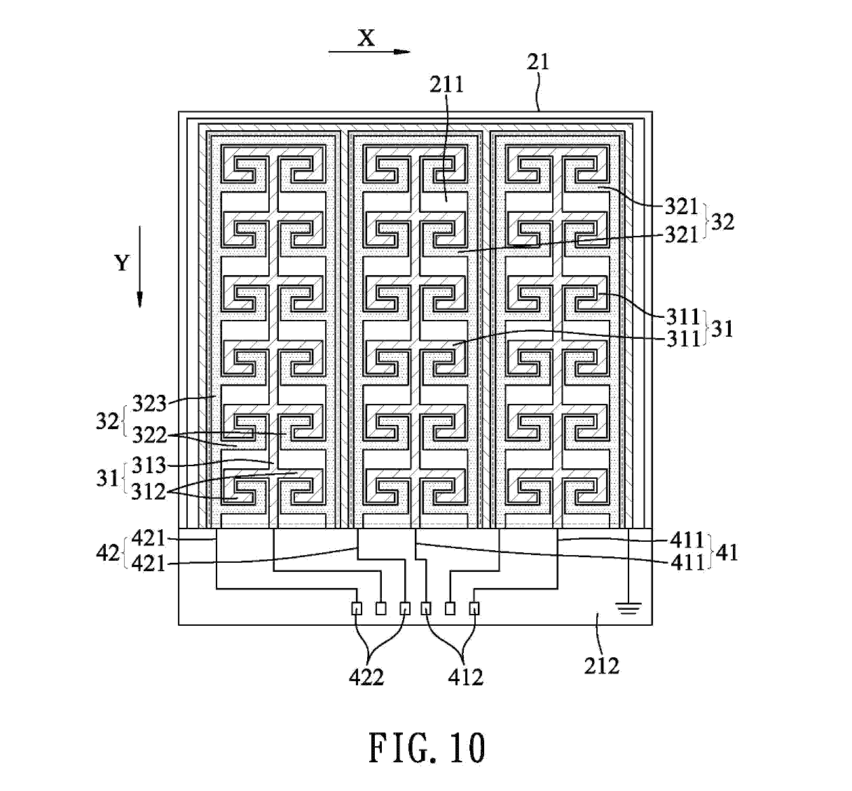

Referring to FIG. 10, the capacitive touch-sensitive device of a seventh exemplary embodiment according to the present disclosure is similar to that of the fourth, fifth or sixth exemplary embodiment, with the difference residing in the detail structure of the first and second sensor electrode layers 31, 32.

As shown in FIG. 10, the first sensor lines 311 are respectively and coplanarly disposed within the second sensor lines 321 to constitute the viewable zone 211 of the lower transparent substrate 21. Each of the first and second sensor lines 311, 321 substantially extend along the second direction (Y), and are mutually spaced apart in the first direction (X). The connecting segments 313 of each of the first sensor lines 311 extend along the second direction (Y), and the sensing zones 312 of the first sensor lines 311 are spaced apart from each other and extend from the connecting segments 313 in the first direction (X) as opposite pairs. The connecting segments 323 of the second sensor lines 321 extend along the second direction (Y) to surround a corresponding one of the first sensor lines 311. The sensing zones 322 of each of the second sensor lines 321 are spaced apart from each other along the second direction (Y) and extend from the corresponding connecting segment 323 as opposite pairs toward a corresponding pair of the connecting segments 312 of the first sensor lines 311. Each of the sensing zones 312 of the first sensor lines 311 and an adjacent one of the sensing zones 322 of the second sensor lines 321 are complementary in shape.

To sum up, by tuning the dispersion density, the average diameter and/or the arrangement of the first conductors 612, 712 and utilizing the metal nano-wires (such as silver nano-wires) as the first and second signal lines 411, 421 of the lower and upper signal trace layers 41, 42, the conducting areas between the first conductors 612, 712 and the outer terminal portions 412, 422 of the lower and upper signal trace layers 41, 42 can be effectively increased, so as to improve the bridging efficiency between the first and second signal lines 411, 421 and the lower and upper flexible circuit board 51, 52 and to prevent the occurrence of the pad-to-pad or line-to-line conductance. As such, the aforesaid problems such as open circuit and signal instability can thus be alleviated.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A capacitive touch-sensitive device, comprising:
a transparent substrate;
a sensor electrode layer disposed on said transparent substrate and including a plurality of mutually electrically isolated sensor lines;
a signal trace layer disposed on said transparent substrate and including a plurality of mutually electrically isolated signal lines, each having an outer terminal portion that is coupled to a respective one of said sensor lines of said sensor electrode layer;
a flexible circuit board having a plurality of mutually electrically isolated bonding pads, each corresponding in position to said outer terminal portion of a respective one of said signal lines of said signal trace layer; and
an electrically-conductive adhesive layer disposed between said outer terminal portions of said signal trace layer and said flexible circuit board and including a plurality of first zones that are spaced apart from each other and that respectively correspond to said outer terminal portions of said signal trace layer, each of said first zones having a first adhesive matrix and a plurality of first conductors dispersed in said first adhesive matrix, wherein said first conductors of each of said first zones electrically bridge the respective one of said outer terminal portions of said signal trace layer to a respective one of said bonding pads of said flexible circuit board.

2. The capacitive touch-sensitive device according to claim 1, wherein:
said electrically-conductive adhesive layer further includes a plurality of second zones that are respectively disposed between adjacent pairs of said first zones, each of said second zones having a second adhesive matrix and a plurality of second conductors dispersed in said second adhesive matrix; and
a dispersion density of said first conductors in each of said first zones is greater than that of said second conductors in said each of said second zones.

3. The capacitive touch-sensitive device according to claim 2, wherein:
the dispersion density of said first conductors in each of said first zones ranges from 750 N(number)/mm² to 4500 N/mm²; and
the dispersion density of said second conductors in each of said second zones is lower than 750 N/mm².

4. The capacitive touch-sensitive device according to claim 2, wherein said first conductors of each of said first zones are mutually electrically coupled, and said second conductors of each of said second zones are mutually electrically isolated.

5. The capacitive touch-sensitive device according to claim 4, wherein said first conductors are configured as spheres, spiked spheres, or wires

6. The capacitive touch-sensitive device according to claim 5, wherein said first conductors are configured in the spherical shape and have an average diameter ranging from 20 μm to 45 μm, said first conductors in each of said first zones being arranged into multiple rows in which said first conductors contact each other and being arranged parallel to an axial direction of each of said outer terminal portions.

7. The capacitive touch-sensitive device according to claim 5, wherein said first conductors are configured as wires and are arranged parallel to an axial direction of each of said outer terminal portions.

8. The capacitive touch-sensitive device according to claim 1, wherein said signal lines of said signal trace layer are made from silver nano-wires.

9. The capacitive touch-sensitive device according to claim 8, wherein said silver nano-wires of said signal trace layer have a diameter ranging from 20 μm to 80 μm.

10. The capacitive touch-sensitive device according to claim 8, wherein a conducting area between said first conductors of each of said first zones and the respective one of said outer terminal portions of said signal trace layer is greater than 500 μm².

11. The capacitive touch-sensitive device according to claim 1, wherein said sensor lines are defined into a plurality of first sensor lines and a plurality of second senor lines, each of the first and second sensor lines having a plurality of mutually spaced-apart sensing zones, and a connecting segment interconnecting said sensing zones, said first sensor lines and said second sensor lines being coplanar, each of said sensing zones of said first sensor lines and a adjacent one of said sensing zones of said second sensor lines are complementary in shape.
